(19) United States
(12) Patent Application Publication
(10) Pub. No.: US 2026/0235052 A1
(43) Pub. Date: Aug. 13, 2026

(54) CYLINDER FOR COMBUSTOR, COMBUSTOR, AND GAS TURBINE

(71) Applicant: MITSUBISHI HEAVY INDUSTRIES, LTD., Tokyo (JP)

(72) Inventors: Kenta TANIGUCHI, Tokyo (JP); Norihiko MOTOYAMA, Tokyo (JP); Taiki KINOSHITA, Tokyo (JP)

(21) Appl. No.: 19/155,451

(22) PCT Filed: Feb. 14, 2024
(86) PCT No.: PCT/JP2024/005058

§ 371 Date: Aug. 11, 2025

(30) Foreign Application Priority Data
Feb. 22, 2023 (JP) 2023-025977

(51) Int. Cl. F01D 25/30; F01D 25/12

(52) U.S. Cl. CPC F01D 25/30; F01D 25/12; F05D 2240/35

(57) ABSTRACT

A cylinder for a combustor, inside which combustion gas generated by combustion of fuel can circulate, includes a cylinder body extending along an axis line. The cylinder body has at least one cooling passage which is formed in a wall part of the cylinder body, which extends in the extension direction of the axis line, and in which a cooling fluid can circulate. The at least one cooling passage has: an inlet opening that is an inlet for the cooling fluid and that opens on a peripheral surface of the cylinder body; and an outlet opening that is an outlet for the cooling fluid and that opens on the peripheral surface of the cylinder body. The inlet opening and/or the outlet opening has a first dimension in the extension direction of the axis line greater than a second dimension in the circumferential direction of the cylinder body.

### TECHNICAL FIELD

The present disclosure relates to a cylinder for a combustor, a combustor, and a gas turbine.

The present application claims priority based on Japanese Patent Application No. 2023-025977 filed in Japan on Feb. 22, 2023, the contents of which are incorporated herein by reference.

### BACKGROUND ART

A combustor in a gas turbine has a structure for cooling the combustor using compressed air or the like from a compressor because high-temperature combustion gas flows inside the combustor. Examples of the structure for cooling the combustor include a cooling passage provided inside a wall of a cylinder constituting the combustor. The cylinder can be cooled by causing the compressed air or the like to flow through the cooling passage (for example, see PTL 1).

### CITATION LIST

### Patent Literature

[PTL 1] Japanese Unexamined Patent Application Publication No. 2009-079789

### SUMMARY OF INVENTION

### Technical Problem

However, a passage width of the cooling passage in a circumferential direction of the cylinder and a pitch between the cooling passages adjacent to each other in the circumferential direction may be restricted from the viewpoint of the strength or manufacturing of the cylinder. Therefore, there is a possibility that it is difficult to sufficiently secure an opening area of an inlet opening or an outlet opening of the cooling passage with respect to a passage cross-sectional area of the cooling passage. When the opening area of the inlet opening or the outlet opening cannot be sufficiently secured, there is a possibility that a pressure loss at the inlet opening or the outlet opening increases, a flow rate of a cooling fluid flowing through the cooling passage decreases, and the cooling performance decreases or the reliability of the combustor decreases.

In view of the above-described circumstances, an object of at least one embodiment of the present disclosure is to provide a cylinder for a combustor, a combustor, and a gas turbine that can suppress a decrease in cooling performance of the cylinder for a combustor.

### Solution to Problem

(1) At least one embodiment of the present disclosure relates to a cylinder for a combustor, in which a combustion gas generated by combustion of fuel is flowable, the cylinder including: a cylinder body extending along an axis, in which the cylinder body includes at least one cooling passage that is formed in a wall portion of the cylinder body, that extends in an extending direction of the axis, and through which a cooling fluid is flowable, the at least one cooling passage has an inlet opening that is an inlet for the cooling fluid and that is open to a circumferential surface of the cylinder body, and an outlet opening that is an outlet for the cooling fluid and that is open to the circumferential surface of the cylinder body, and at least any one of the inlet opening or the outlet opening has a first dimension in the extending direction of the axis that is larger than a second dimension in a circumferential direction of the cylinder body.
(2) At least one embodiment of the present disclosure relates to a combustor including: the cylinder for a combustor according to (1); and a burner that injects fuel.
(3) At least one embodiment of the present disclosure relates to a gas turbine including: the combustor according to (2); a compressor that generates compressed air to be delivered to the combustor; and a turbine including a rotor that rotates by means of a combustion gas delivered from the combustor.

### Advantageous Effects of Invention

According to at least one embodiment of the present disclosure, it is possible to provide the cylinder for a combustor, the combustor, and the gas turbine that can improve the cooling performance of the cylinder for a combustor.

### BRIEF DESCRIPTION OF DRAWINGS

FIG. 1 is a schematic view illustrating an overall configuration of a gas turbine according to an embodiment.

FIG. 2 is a view illustrating an example of a combustor of the gas turbine according to the embodiment and a peripheral structure thereof.

FIG. 3 is a schematic view illustrating a cylinder for a combustor according to the embodiment.

FIG. 4 is a schematic enlarged view of a cross section of the cylinder for a combustor according to the embodiment when viewed in a circumferential direction.

FIG. 5 is a cross-sectional view taken along line V-V of FIG. 4.

FIG. 6 is a cross-sectional view taken along line VI-VI of FIG. 5.

FIG. 7 is a view corresponding to a cross-sectional view taken along line V-V of FIG. 4, which is a view illustrating another example of an inlet opening.

FIG. 8 is a view corresponding to a cross-sectional view taken along line V-V of FIG. 4, which is a view illustrating another example of the inlet opening.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples.

For example, the expression representing a relative or absolute disposition such as “in a certain direction”, “along a certain direction”, “parallel”, “orthogonal”, “center”, “concentric”, or “coaxial” not only strictly represents such a disposition, but also represents a state where the disposition is relatively displaced with a tolerance or at an angle or a distance to such an extent that the same function can be obtained.

For example, the expression representing that matters are in an equal state such as “same”, “equal”, or “homogeneous” not only strictly represents an equal state, but also represents a state where a difference exists with a tolerance or to such an extent that the same function can be obtained.

For example, the expression representing a shape such as a quadrangular shape or a cylindrical shape not only represents a shape such as a quadrangular shape or a cylindrical shape in a geometrically strict sense, but also represents shapes including an uneven portion or a chamfered portion within a range in which the same effect can be obtained.

In addition, the expression of “provided with”, “equipped with”, “include”, or “have” one component is not an exclusive expression excluding the presence of other components.

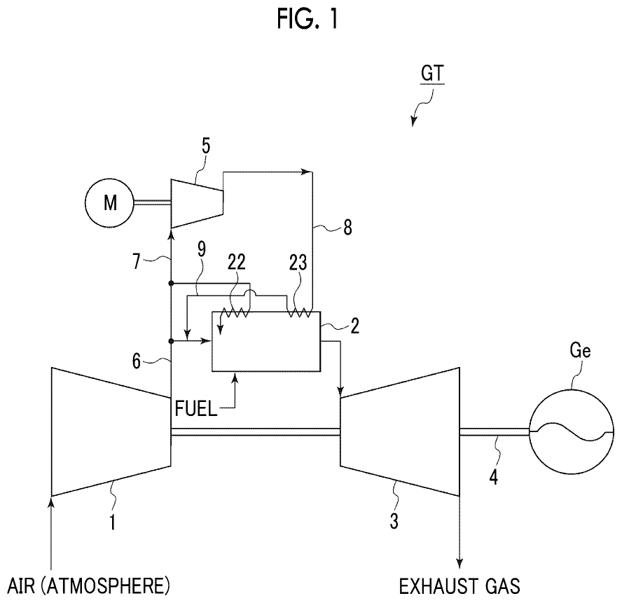

A cylinder for a combustor, a combustor, and a gas turbine according to the embodiment will be described with reference to FIGS. 1 to 8.

FIG. 1 is a schematic view illustrating an overall configuration of the gas turbine according to the embodiment.

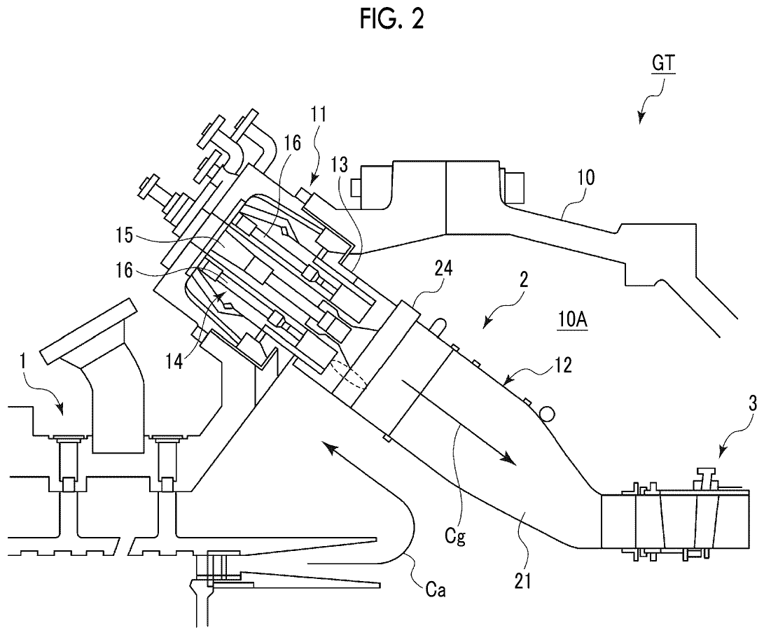

FIG. 2 is a view illustrating an example of the combustor of the gas turbine according to the embodiment and a peripheral structure thereof.

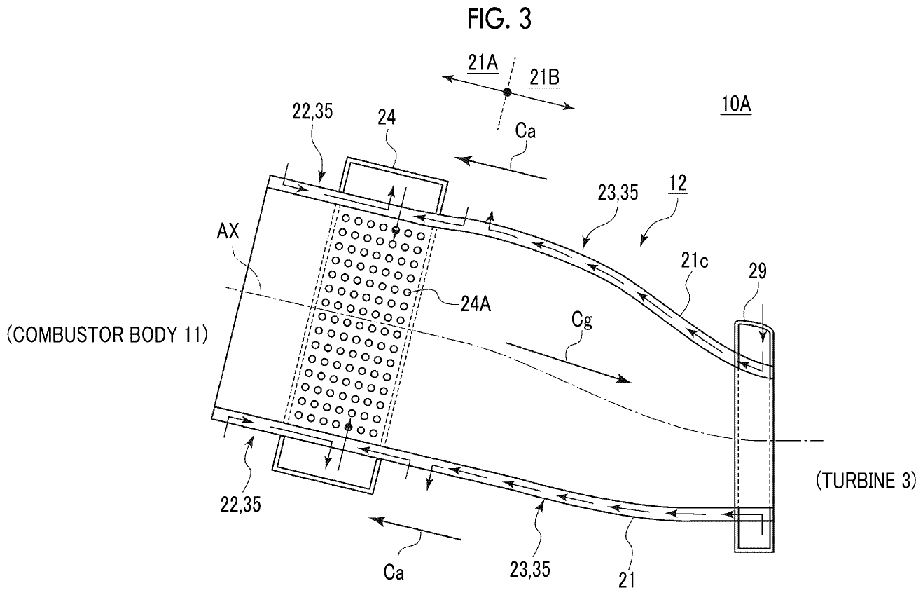

FIG. 3 is a schematic view illustrating the cylinder for a combustor according to the embodiment.

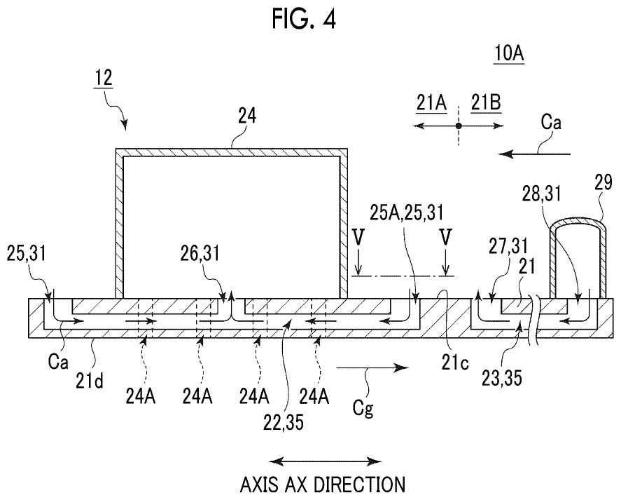

FIG. 4 is a schematic enlarged view of a cross section of the cylinder for a combustor according to the embodiment when viewed in a circumferential direction.

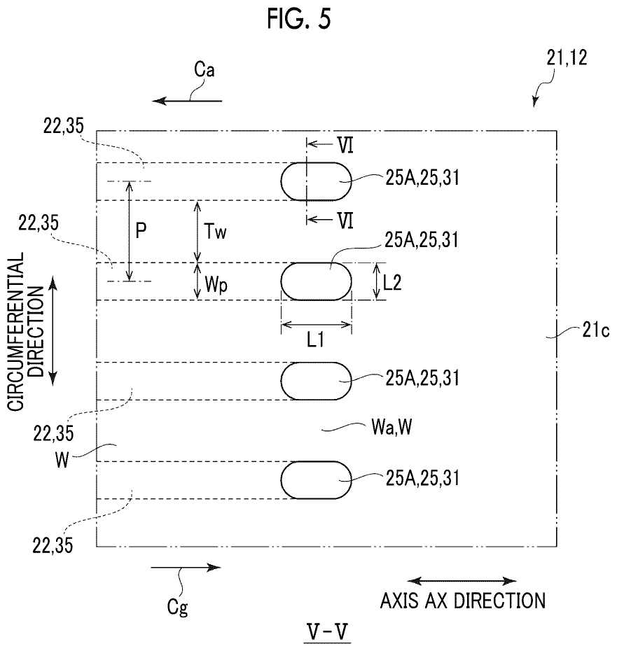

FIG. 5 is a cross-sectional view taken along line V-V of FIG. 4.

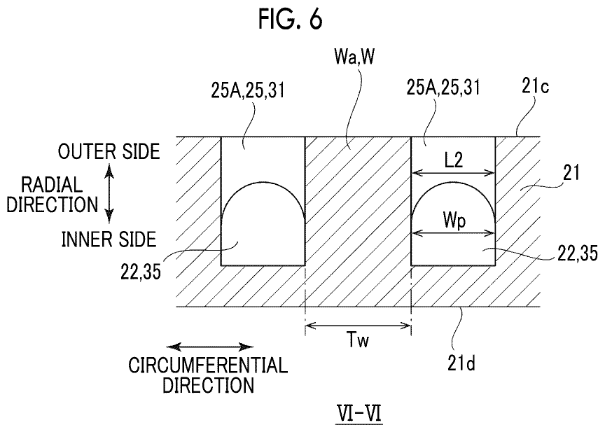

FIG. 6 is a cross-sectional view taken along line VI-VI of FIG. 5.

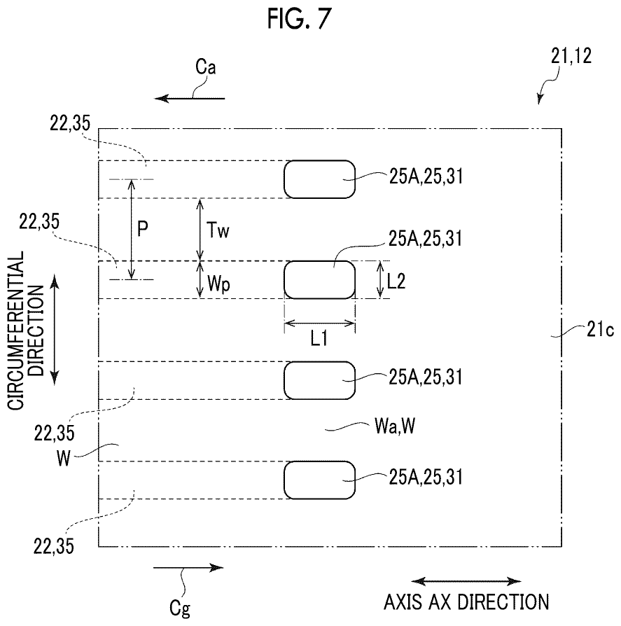

FIG. 7 is a view corresponding to a cross-sectional view taken along line V-V of FIG. 4, which is a view illustrating another example of an inlet opening.

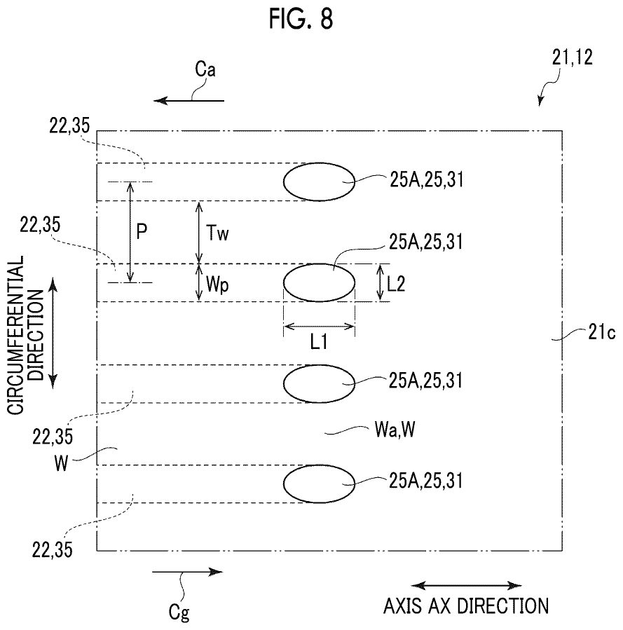

FIG. 8 is a view corresponding to a cross-sectional view taken along line V-V of FIG. 4, which is a view illustrating another example of the inlet opening.

As illustrated in FIG. 1, a gas turbine GT according to the present embodiment includes a compressor 1, a combustor 2, and a turbine 3.

The compressor 1 generates compressed air by taking in air as a working fluid from an air intake port.

The combustor 2 is connected to a discharge port of the compressor 1. The combustor 2 injects fuel into the compressed air discharged from the compressor 1, to generate a high-temperature and high-pressure combustion gas.

The turbine 3 converts thermal energy of the combustion gas delivered from the combustor 2 into rotational energy of a rotor 4 to generate a driving force. The turbine 3 transmits the generated driving force to a generator Ge connected to the rotor 4.

The gas turbine GT according to the present embodiment is further provided with a boosting device 5 that bleeds a part of the compressed air compressed by the compressor 1 and that boosts the bled air to a pressure higher than the pressure of the compressed air. The boosting device 5 is provided in a branch flow channel 7 that branches off from the middle of a compressed air supply flow channel 6 for supplying the compressed air from the compressor 1 to the combustor 2 and that bleeds a part of the compressed air, and is driven by, for example, an electric motor M.

The bled boosted air boosted by the boosting device 5 is supplied to the combustor 2 through a boosted air flow channel 8, and is used as air (hereinafter, referred to as cooling air) for cooling a transition piece 21 of the combustor 2 which will be described later. The cooling air used for cooling the transition piece 21 is returned to the compressed air supply flow channel 6 through a return flow channel 9, merges with a main stream of the compressed air flowing through the compressed air supply flow channel 6, and then is reused as combustion air for the combustion of the fuel in the combustor 2.

That is, the gas turbine GT according to the present embodiment has a recovery type air cooling structure (closed cooling cycle structure) in which a part of the compressed air that is supplied from the compressor 1 and that is used as the combustion air in the combustor 2 is used as the cooling air for cooling the transition piece 21 of the combustor 2, and then the cooling air is recovered and reused as the combustion air in the combustor 2 together with the main stream of the compressed air.

As illustrated in FIG. 1, a part of the compressed air bled from the main stream (compressed air supply flow channel 6) is not limited to being used only for cooling the transition piece 21 of the combustor 2, and may be used, for example, for cooling a stator blade or a rotor blade of the turbine 3 in addition to cooling the transition piece 21 of the combustor 2.

The combustor 2 has a substantially cylindrical external appearance, and is disposed in a casing internal space 10A formed mainly in a casing 10 (casing) of the gas turbine GT, for example, as illustrated in FIG. 2. The compressed air compressed in the compressor 1 is introduced to fill the casing internal space 10A in which the combustor 2 is disposed. The combustor 2 includes a combustor body 11 and a cylinder for a combustor 12.

The combustor body 11 functions as a combustion chamber that causes the supplied fuel and the compressed air, which is discharged from the compressor 1, to react with each other. The cylinder for a combustor 12 delivers the combustion gas that has flowed in from the combustor body 11 to the turbine 3.

The combustor body 11 includes a cylindrical inner tube 13, and a burner 14 that is disposed in the inner tube 13 and that injects fuel.

One opening of the inner tube 13 is an upstream-side opening for introducing the compressed air that has filled the casing internal space 10A into the inner tube 13. The other opening of the inner tube 13 is a downstream-side opening, and the transition piece 21 (which will be described later) is connected thereto.

The burner 14 includes a pilot burner 15 and a main burner 16. The pilot burner 15 is provided along a central axis of the inner tube 13. The pilot burner 15 injects the fuel supplied from the outside to perform diffusion combustion of the fuel. A plurality of main burners 16 are provided in the inner tube 13. The plurality of main burners 16 are arranged at intervals in a circumferential direction of the inner tube 13 to surround the pilot burner 15. Each main burner 16 extends parallel to the central axis of the inner tube 13. The main burner 16 injects the fuel, generates a premixed gas by mixing the fuel and the compressed air in advance, and then injects the premixed gas to perform premixed combustion.

As illustrated in FIGS. 2 to 4, the cylinder for a combustor 12 includes the transition piece (cylinder body) 21, a first cooling passage 22, a second cooling passage 23, and an acoustic liner 24.

The transition piece 21 extends along an axis AX, and accelerates a flow rate of a combustion gas Cg that has flowed in from the combustor body 11 inside to introduce the combustion gas Cg into the turbine 3. One opening of the transition piece 21 is connected to the above-described downstream-side opening of the inner tube 13 (see FIG. 2) of the combustor body 11. The other opening of the transition piece 21 is connected to the turbine 3. The combustion gas Cg that has flowed from the combustor body 11 flows inside the transition piece 21. In FIGS. 3 to 5, 7, and 8, inside the transition piece 21, the combustion gas Cg flows from a left side (upstream side) to a right side (downstream side) of a paper surface. In a space outside the transition piece 21, that is, in the casing internal space 10A, compressed air Ca discharged from the compressor 1 flows in a direction opposite to a circulation direction of the combustion gas Cg in the transition piece 21 to head for the above-described upstream-side opening of the inner tube 13.

The first cooling passage 22 is formed in an upstream-side region 21A located on an upstream side in the circulation direction of the combustion gas Cg in a wall portion of the transition piece 21. The first cooling passage 22 has an inlet opening 25 that is open to an outer peripheral surface 21c of the transition piece 21. As a result, the first cooling passage 22 cools the upstream-side region 21A of the transition piece 21 by introducing the compressed air (fluid) Ca as first cooling air (first cooling fluid) from the casing internal space 10A through the inlet opening 25.

The first cooling passage 22 according to the present embodiment extends along the axis AX direction of the transition piece 21. A plurality of first cooling passages 22 are arranged at intervals in a circumferential direction of the transition piece 21.

One inlet opening 25 of each first cooling passage 22 is provided on each of both sides of the acoustic liner 24 provided in the upstream-side region 21A of the transition piece 21 in the circulation direction of the combustion gas Cg. Inlet openings 25A (hereinafter, referred to as downstream-side inlet openings 25A) of the plurality of first cooling passages 22 located on the downstream side in the circulation direction of the combustion gas Cg with respect to the acoustic liner 24 are arranged in a row in the circumferential direction of the transition piece 21.

Each first cooling passage 22 has an outlet opening 26 that is open to the outer peripheral surface 21c of the transition piece 21 and that discharges the first cooling air to the outside of the transition piece 21. The outlet opening 26 of the first cooling passage 22 is open to the inside of the acoustic liner 24. That is, the first cooling air cools the upstream-side region 21A of the transition piece 21, and then is discharged into the acoustic liner 24.

The second cooling passage 23 is formed in a downstream-side region 21B that is located continuously on the downstream side in the circulation direction of the combustion gas Cg with respect to the upstream-side region 21A of the transition piece 21 in the wall portion of the transition piece 21. The second cooling passage 23 cools the downstream-side region 21B of the transition piece 21 by receiving supply of the bled boosted air boosted by the boosting device 5 (see FIG. 1) as second cooling air (second cooling fluid) to the second cooling passage 23. The second cooling passage 23 has an outlet opening 27 that is open on the downstream side of the downstream-side inlet opening 25A in the outer peripheral surface 21c of the transition piece 21 and through which the second cooling air is discharged into the casing internal space 10A.

The second cooling passage 23 according to the present embodiment extends along the axis AX direction of the transition piece 21. A plurality of second cooling passages 23 are arranged at intervals in the circumferential direction of the transition piece 21.

The outlet opening 27 of each second cooling passage 23 is provided at a first end portion in a longitudinal direction of the second cooling passage 23 located on the upstream side in the circulation direction of the combustion gas Cg. The outlet openings 27 of the plurality of second cooling passages 23 are arranged in a row in the circumferential direction of the transition piece 21.

Each second cooling passage 23 has an inlet opening 28 that is open to the outer peripheral surface 21c of the transition piece 21 and through which the second cooling air is introduced into the second cooling passage 23. The inlet opening 28 of the second cooling passage 23 is provided at a second end portion of the second cooling passage 23 in the longitudinal direction, and is located at a downstream-side end portion of the transition piece 21 located on the turbine 3 side.

The outer peripheral surface 21c of the downstream-side end portion of the transition piece 21 is provided with an annular passage portion 29 (manifold) that is formed over the entire circumferential direction of the transition piece 21, that collectively covers the inlet openings 28 of the plurality of second cooling passages 23, and that forms an introduction space communicating with the inlet openings 28 of the second cooling passages 23. The introduction space of the annular passage portion 29 is formed not to communicate with the casing internal space 10A. As a result, the second cooling air (bled boosted air boosted by the boosting device 5) is supplied to each second cooling passage 23 from the inlet opening 28 of each second cooling passage 23 via the annular passage portion 29.

The second cooling air supplied to the second cooling passage 23 cools the downstream-side region 21B of the transition piece 21, and then is discharged into the casing internal space 10A. Since the second cooling air is heated by cooling the wall portion of the transition piece 21 in the second cooling passage 23, when the second cooling air is discharged from the outlet opening 27 of the second cooling passage 23, the second cooling air becomes high-temperature air (high-temperature fluid) having a temperature higher than a temperature of the second cooling air in the inlet opening 28 of the second cooling passage 23 and a temperature of the compressed air Ca that fills the casing internal space 10A. The high-temperature air (second cooling air) discharged into the casing internal space 10A merges with the compressed air Ca that fills the casing internal space 10A, and is reused as the combustion air.

In the cylinder for a combustor 12 according to some embodiments, in order to make it difficult for the high-temperature air, which is discharged from the outlet opening 27 of the second cooling passage 23, to be directly supplied to the first cooling passage 22 from the down-side inlet opening 25A, a wall portion (not illustrated) or the like may be provided.

The acoustic liner 24 is provided on an outer periphery of the transition piece 21 in the upstream-side region 21A. A part of the acoustic liner 24 is formed by the wall portion of the transition piece 21. An internal space of the acoustic liner 24 communicates with the inside of the transition piece 21 through a large number of acoustic holes 24A formed to penetrate the wall portion of the transition piece 21. For this reason, the first cooling passage 22 described above is provided at a position that does not interfere with the acoustic hole 24A. The acoustic liner 24 reduces combustion vibration (self-excited vibration that occurs due to feedback of pressure fluctuation, speed fluctuation, and heat generation rate fluctuation inside the combustor 2) of the gas turbine GT.

Since the acoustic liner 24 is provided with the acoustic holes 24A as described above, the first cooling air discharged into the acoustic liner 24 from the outlet opening 26 of the first cooling passage 22 described above flows into the inside of the transition piece 21 through the acoustic holes 24A.

### Regarding Inlet Openings 25 and 28 and Outlet Openings 26 and 27

The shapes of the inlet openings 25 and 28 and the outlet openings 26 and 27 will be described with reference to FIGS. 5 to 8. In FIGS. 5 to 8, the downstream-side inlet opening 25A of the first cooling passage 22 is illustrated, but the following description also applies to the inlet opening 25 other than the downstream-side inlet opening 25A, the inlet opening 28 of the second cooling passage 23, and the outlet openings 26 and 27.

In the following description, in a case where it is not necessary to particularly distinguish between the inlet openings 25 and 28 and the outlet openings 26 and 27 or in a case where the inlet openings 25 and 28 and the outlet openings 26 and 27 are collectively referred to, the inlet openings 25 and 28 and the outlet openings 26 and 27 may be simply referred to as openings 31.

Similarly, in the following description, in a case where it is not necessary to particularly distinguish between the first cooling passage 22 and the second cooling passage 23 or in a case where the first cooling passage 22 and the second cooling passage 23 are collectively referred to, the first cooling passage 22 and the second cooling passage 23 may be simply referred to as a cooling passage 35.

For example, a passage width Wp of the cooling passage 35 in the circumferential direction and a pitch P between the cooling passages 35 adjacent to each other in the circumferential direction may be restricted from the viewpoint of the strength or manufacturing of the cylinder for a combustor 12 (transition piece 21). Therefore, there is a possibility that it is difficult to sufficiently secure an opening area of the opening 31 of the cooling passage 35 with respect to a passage cross-sectional area of the cooling passage 35, that is, an area of a cross section of the cooling passage 35 illustrated in a paper surface of FIG. 6. When the opening area of the opening 31 cannot be sufficiently secured, there is a possibility that a pressure loss at the opening 31 increases, a flow rate of cooling air that is a cooling fluid flowing through the cooling passage 35 decreases, and the cooling performance decreases or the reliability of the combustor 2 decreases.

Therefore, in the cylinder for a combustor 12 according to some embodiments, for at least any one of the inlet openings 25 and 28 or the outlet openings 26 and 27, a first dimension L1 in the axis AX direction is made larger than a second dimension L2 in the circumferential direction of the transition piece 21.

As a result, even in a case where there is a restriction on increasing the dimensions of the inlet openings 25 and 28 or the outlet openings 26 and 27 in the circumferential direction, the opening area can be secured by increasing the first dimension L1. As a result, since the pressure loss of the cooling air in at least any one of the inlet openings 25 and 28 or the outlet openings 26 and 27 can be suppressed, the decrease in flow rate of the cooling air flowing through the cooling passages 35 can be suppressed, and the cooling performance can be improved.

In addition, with the combustor 2 in some embodiments, since the pressure loss of the cooling air in at least any one of the inlet openings 25 and 28 or the outlet openings 26 and 27 can be suppressed, the decrease in flow rate of the cooling air flowing through the cooling passage 35 can be suppressed, and the cooling performance of the cylinder for a combustor 12 can be improved. As a result, the reliability of the combustor 2 can be improved.

In addition, with the gas turbine GT in some embodiments, the reliability of the combustor 2 is improved, so that the reliability of the gas turbine GT can be improved.

Examples of a case where there is a restriction on increasing the second dimension L2 of the opening 31 include a case where, when the second dimension L2 is increased, a thickness Tw in the circumferential direction of a wall Wa located between the openings 31 adjacent to each other in the circumferential direction among the walls W that separate the cooling passages 35 adjacent to each other in the circumferential direction is reduced, which is not preferable from the viewpoint of the strength of the wall Wa or the durability of the cylinder for a combustor 12.

In addition, for example, it is assumed that the transition piece 21 is formed by arranging plate-shaped members, in which a plurality of cooling passages 35 are formed, in the circumferential direction and joining the end portions of the members, which are adjacent to each other in the circumferential direction, to each other by welding. In this case, when the second dimension L2 of the opening 31 is increased for the cooling passage 35 formed in the vicinity of a welding portion (welding portion extending along the axis AX) between the end portions, there is a possibility that the opening 31 reaches a heat-affected part or molten metal of the welding portion. Therefore, even in this case, there is a restriction on increasing the second dimension L2 of the opening 31.

In the cylinder for a combustor 12 according to some embodiments, the second dimension L2 may be equal to the passage width Wp of at least one cooling passage 35 in the circumferential direction.

As a result, since the thickness Tw of the wall W (wall Wa) in the circumferential direction that separates the cooling passage 35 is not reduced, the opening area of the opening 31 can be secured while suppressing the influence on the strength of the cylinder for a combustor 12.

In the cylinder for a combustor 12 according to some embodiments, the at least one cooling passage 35 may include a plurality of cooling passages 35 disposed at intervals in the circumferential direction.

As a result, the cooling performance of the cylinder for a combustor 12 can be improved. In addition, according to the above-described configuration, since the thickness Tw of the wall W that separates the cooling passages 35 adjacent to each other in the circumferential direction can be easily secured in at least any one of the inlet openings 25 and 28 or the outlet openings 26 and 27, the opening area can be secured while suppressing the influence on the strength of the cylinder for a combustor 12.

In the cylinder for a combustor 12 according to some embodiments, the thickness Tw in the circumferential direction of the wall W that separates the cooling passages 35 adjacent to each other in the circumferential direction may be equal to or less than 4.0 times the passage width Wp of the cooling passage 35 in the circumferential direction.

As a result, the number of cooling passages 35 per unit area of the cylinder for a combustor 12 can be increased, and the cooling performance of the cylinder for a combustor 12 can be improved.

As the thickness Tw in the circumferential direction of the wall W that separates the cooling passages 35 adjacent to each other in the circumferential direction decreases, the influence of the magnitude of the second dimension L2 of the opening 31 on the strength of the wall W (wall Wa) increases.

According to the above-described configuration, since the first dimension L1 is larger than the second dimension L2, the opening area can be secured while securing the strength of the wall W (wall Wa) that separates the cooling passages 35 adjacent to each other in the circumferential direction.

In the cylinder for a combustor 12 according to some embodiments, the first dimension L1 may be equal to or more than 1.5 times and equal to or less than 2.0 times the second dimension L2.

As a result, the opening area can be secured while suppressing the decrease in strength of the cylinder for a combustor 12 due to the provision of the opening 31.

In the cylinder for a combustor 12 according to some embodiments, the shape of at least any one of the inlet openings 25 and 28 or the outlet openings 26 and 27 when viewed from a radial direction may be any one of a long-hole shape as illustrated in FIG. 5, a rectangular shape with rounded corners as illustrated in FIG. 7, or an elliptical shape as illustrated in FIG. 8.

As a result, the concentration of the stress or the like at an opening peripheral edge can be mitigated in at least any one of the inlet openings 25 and 28 or the outlet openings 26 and 27, and the openings 31 can be relatively easily processed.

The present disclosure is not limited to the above-described embodiments, and also includes a form in which modifications are added to the above-described embodiments or a form in which the embodiments are combined with each other as appropriate.

For example, in a case where an opening that is open to an inner peripheral surface 21d of the transition piece 21 is present, the contents of the above description may be applied to a first dimension of the opening in the axis AX direction and a second dimension of the opening in the circumferential direction.

The contents described in each embodiment are understood, for example, as follows.
(1) A cylinder for a combustor 12 according to at least one embodiment of the present disclosure is a cylinder for a combustor 12 in which a combustion gas Cg generated by combustion of fuel is flowable, and includes a cylinder body (transition piece 21) extending along an axis AX. The cylinder body (transition piece 21) includes at least one cooling passage 35 (first cooling passage 22 and second cooling passage 23) that is formed in a wall portion of the cylinder body (transition piece 21), that extends in an extending direction of the axis AX (axis AX direction), and through which a cooling fluid (cooling air) is flowable. The at least one cooling passage 35 (first cooling passage 22 and second cooling passage 23) has inlet openings 25 and 28 that are inlets for the cooling fluid (cooling air) and that are open to a peripheral surface of the cylinder body (transition piece 21), and outlet openings 26 and 27 that are outlets for the cooling fluid (cooling air) and that are open to the peripheral surface of the cylinder body (transition piece 21). At least any one of the inlet openings 25 and 28 or the outlet openings 26 and 27 has a first dimension L1 in the extending direction of the axis AX (axis AX direction) larger than a second dimension L2 in a circumferential direction of the cylinder body (transition piece 21).

According to the configuration of (1) described above, since the first dimension L1 in the extending direction of the axis AX (axis AX direction) is made larger than the second dimension L2 in the circumferential direction of the cylinder body (transition piece 21), even in a case where there is a restriction on increasing the dimensions of the inlet openings 25 and 28 or the outlet openings 26 and 27 in the circumferential direction, the opening area can be secured. As a result, since the pressure loss of the cooling fluid (cooling air) in at least any one of the inlet openings 25 and 28 or the outlet openings 26 and 27 can be suppressed, the decrease in flow rate of the cooling fluid (cooling air) flowing through the cooling passage 35 (first cooling passage 22 and second cooling passage 23) can be suppressed, and the cooling performance can be improved.
(2) In some embodiments, in the configuration of (1) described above, the second dimension L2 may be equal to a passage width Wp of the at least one cooling passage 35 (first cooling passage 22 and second cooling passage 23) in the circumferential direction.

According to the configuration of (2) described above, since the thickness of the wall W in the circumferential direction that separates the cooling passage 35 (first cooling passage 22 and second cooling passage 23) is not reduced, the opening area can be secured while suppressing the influence on the strength of the cylinder for a combustor 12.
(3) In some embodiments, in the configuration of (1) or (2) described above, the at least one cooling passage 35 (first cooling passage 22 and second cooling passage 23) may include a plurality of cooling passages 35 (first cooling passage 22 and second cooling passage 23) disposed at intervals in the circumferential direction.

According to the configuration of (3) described above, the cooling performance of the cylinder for a combustor 12 can be improved. In addition, according to the configuration of (3) described above, since the thickness Tw of the wall W that separates the cooling passages 35 (first cooling passage 22 and second cooling passage 23) adjacent to each other in the circumferential direction can be easily secured in at least any one of the inlet openings 25 and 28 or the outlet openings 26 and 27, the opening area can be secured while suppressing the influence on the strength of the cylinder for a combustor 12.
(4) In some embodiments, in the configuration of (3) described above, a thickness Tw in the circumferential direction of a wall W that separates the cooling passages 35 (first cooling passage 22 and second cooling passage 23) adjacent to each other in the circumferential direction may be equal to or less than 4.0 times a passage width Wp of the cooling passage 35 (first cooling passage 22 and second cooling passage 23) in the circumferential direction.

According to the configuration of (4) described above, the number of cooling passages 35 (first cooling passage 22 and second cooling passage 23) per unit area of the cylinder for a combustor 12 can be increased, and the cooling performance of the cylinder for a combustor 12 can be improved.

According to the configuration of (4) described above, since the first dimension L1 in the extending direction of the axis AX (the axis AX direction) is larger than the second dimension L2 in the circumferential direction of the cylinder body (the transition piece 21), the opening area can be secured while securing the strength of the wall W that separates the cooling passages 35 (first cooling passage 22 and second cooling passage 23) adjacent to each other in the circumferential direction.
(5) In some embodiments, in the configuration of any one of (1) to (4) described above, the first dimension L1 may be equal to or more than 1.5 times and equal to or less than 2.0 times the second dimension L2.

According to the configuration of (5) described above, the opening area can be secured while suppressing the decrease in strength of the cylinder for a combustor 12 due to the provision of the openings 31 (inlet openings 25 and 28 and outlet openings 26 and 27).
(6) In some embodiments, in the configuration of any one of (1) to (5), a shape of at least any one of the inlet openings 25 and 28 or the outlet openings 26 and 27 when viewed in a radial direction of the axis AX may be any one of a long-hole shape, a rectangular shape with rounded corners, or an elliptical shape.

According to the configuration of (6) described above, the concentration of the stress or the like on the peripheral edge of the opening can be mitigated in at least any one of the inlet openings 25 and 28 or the outlet openings 26 and 27, and the openings 31 (inlet openings 25 and 28 and outlet openings 26 and 27) can be relatively easily processed.
(7) A combustor 2 according to at least one embodiment of the present disclosure includes the cylinder for a combustor 12 according to the configuration of any one of (1) to (6), and a burner 14 that injects fuel.

According to the configuration of (7) described above, since the pressure loss of the cooling fluid (cooling air) in at least any one of the inlet openings 25 and 28 or the outlet openings 26 and 27 can be suppressed, the decrease in flow rate of the cooling fluid (cooling air) flowing through the cooling passage 35 (first cooling passage 22 and second cooling passage 23) can be suppressed, and the cooling performance of the cylinder for a combustor 12 can be improved. As a result, the reliability of the combustor 2 can be improved.
(8) A gas turbine GT according to at least one embodiment of the present disclosure includes the combustor 2 according to the configuration of (7), a compressor 1 that generates compressed air to be delivered to the combustor 2, and a turbine 3 including a rotor 4 that rotates by means of a combustion gas Cg delivered from the combustor 2.

According to the configuration of (8) described above, since the reliability of the combustor 2 is improved, the reliability of the gas turbine GT can be improved.

### REFERENCE SIGNS LIST

1: compressor
2: combustor
3: turbine
4: rotor
5: boosting device
10: casing (casing)
10A: casing internal space
11: combustor body
12: cylinder for combustor
21: transition piece (cylinder body)
21c: outer peripheral surface
22: first cooling passage
23: second cooling passage
25: inlet opening
25A: inlet opening (downstream-side inlet opening)
26: outlet opening
27: outlet opening
28: inlet opening
31: opening
35: cooling passage

1. A cylinder for a combustor, in which a combustion gas generated by combustion of fuel is flowable, the cylinder comprising:
a cylinder body extending along an axis,
wherein the cylinder body includes at least one cooling passage that is formed in a wall portion of the cylinder body, that extends in an extending direction of the axis, and through which a cooling fluid is flowable,
the at least one cooling passage has
an inlet opening that is an inlet for the cooling fluid and that is open to a circumferential surface of the cylinder body, and
an outlet opening that is an outlet for the cooling fluid and that is open to the circumferential surface of the cylinder body, and
at least any one of the inlet opening or the outlet opening has a first dimension in the extending direction of the axis that is larger than a second dimension in a circumferential direction of the cylinder body.

2. The cylinder for a combustor according to claim 1,
wherein the second dimension is equal to a passage width of the at least one cooling passage in the circumferential direction.

3. The cylinder for a combustor according to claim 1,
wherein the at least one cooling passage includes a plurality of the cooling passages disposed at intervals in the circumferential direction.

4. The cylinder for a combustor according to claim 3,
wherein a thickness of a wall in the circumferential direction that separates the cooling passages adjacent to each other in the circumferential direction is equal to or less than 4.0 times a passage width of the cooling passages in the circumferential direction.

5. The cylinder for a combustor according to claim 1,
wherein the first dimension is equal to or more than 1.5 times and equal to or less than 2.0 times the second dimension.

6. The cylinder for a combustor according to claim 1,
wherein a shape of at least any one of the inlet opening or the outlet opening when viewed from a radial direction of the axis is any one of a long-hole shape, a rectangular shape with rounded corners, or an elliptical shape.

7. A combustor comprising:
the cylinder for a combustor according to claim 1; and
a burner that injects fuel.

8. A gas turbine comprising:
the combustor according to claim 7;
a compressor that generates compressed air to be delivered to the combustor; and
a turbine including a rotor that rotates by means of a combustion gas delivered from the combustor.
